(19) United States
(12) Patent Application Publication
(10) Pub. No.: US 2014/0205069 A1
(43) Pub. Date: Jul. 24, 2014

(54) X-ray monitoring camera

(71) Applicant: Joseph Stanly Hecker, Rapid City, SD (US)

(72) Inventor: Joseph Stanly Hecker, Rapid City, SD (US)

(21) Appl. No.: 13/694,995

(22) Filed: Jan. 23, 2013

(51) Int. Cl. G01T 1/00

(52) U.S. Cl. CPC G01T 1/00
USPC 378/98.2

(57) ABSTRACT

A x-ray monitoring camera is disclosed which uses a camera mounted in a collimator to monitor the field of the x-ray on the patient to better direct the x-ray. The camera of the x-ray monitoring camera may also be used to record and capture still or video images of the area x-rayed.

### BACKGROUND OF THE INVENTION

### Field of the Invention

The present invention relates generally to x-ray devices and more specifically to a monitoring camera which may be used to show the area of the patient to be x-rayed.

### Background Information

For a great many years people have been using x-rays in the diagnosis and treatment of illness and injury in humans and animals and non-living matter such as is used in non-destructive testing (NDT). Nearly all x-ray devices include an x-ray emitter, a collimator, and x-ray recording media. In the past most x-rays were recorded on film, but more and more often they are being saved as digital images. The collimator is interposed between the x-ray emitter and the patient and serves, chiefly, to control the x-ray. Nearly all collimators have a series of lead plates which may be moved to “frame” the x-ray such that it moves through a size adjustable frame. The collimator mounted at the output of the x-ray emitted and is used to control the x-ray field coverage area and to provide a visual indication of the x-ray field area. Nearly all collimators have a series of lead plates which may be moved to “frame” the x-rays as they travel through a field size adjustable, leaded frame.

The collimator is a very important part of any x-ray system for several reasons, the most important being the safety of the operator. Prolonged exposure to x-rays causes harmful effects to living tissue and an operator must be able to limit the x-ray filed size to the area of interest and determine the correct projection of the x-ray beam and the correct position of a patient before the x-ray is taken. In an effort to assist an operator to properly set the x-ray beam, most collimators include a small lamp and a mirror. The lamp is placed on one side of the interior of the collimator and the mirror is place inside the collimator and is near the rear and centered in the collimator. The rear is considered to be the portion of the collimator closest to the x-ray emitter. The mirror is angled such that the light emitted from the lamp reflects off the mirror and is directed straight out into the same area as the x-rays would at the time of exposure. X-rays can't be seen with the human eye, but the light projected from the collimator lamp provides a visual indication of the x-ray field position and coverage area. Therefore, the light helps the operator to insure that the correct area of the patient is being x-rayed. A large percentage of modern collimators include a window at the output side of the collimator and the window includes a cross hair. The collimator lamp casts a shadow image of the cross hair onto the surface of the patient. This provides a valuable tool for an operator to use to properly aim and position the x-ray.

The collimator lamp and mirror system described above provides valuable assistance in aiming an x-ray, but it does not act to record a pictorial image of the area being x-rayed at the moment when the x-ray is taken. The device of the instant invention replaces the lamp with a camera.

The x-ray monitoring camera of the instant invention solves the above problems by providing not only a method of correctly aiming an x-ray field, but also a method of recording a pictorial image of the moment the x-ray is taken. The device is also simple, reliable, inexpensive, and easy to operate and maintain.

### SUMMARY OF THE INVENTION

A modern x-ray system includes an x-ray emitter, a collimator, and x-ray arial image recording device. The x-ray producing device (emitter) emits an x-ray which passes through the collimator to create a collimated field and the patient to the recording media. In the past, virtually all x-rays were recorded on film, but more and more often, the x-ray arial image is recorded as a digital image rather than on film. The collimator ordinarily includes a pair of lead shutters which may be manipulated to frame the x-ray into a collimated beam. That is, the shutters form an open rectangle which prevents x-rays not inside the rectangle from moving through the collimator. This allows an operator to control the size of the projected x-ray field. The front face of the collimator, which is furthest from the emitter, includes a glass or plastic plate which has a cross hair across the middle of the projected x-ray beam. There is a lamp inside the collimator off to one side such that it doesn't impinge upon the x-ray. There is a mirror angled across the path of the x-ray which is at an angle such that the light from the lamp reflects off of the mirror and follows the exact path of the x-ray through and our of the collimator. (X-rays pass through the mirror.) The light from the lamp causes the image of the cross hairs to be projected onto the surface of the patient. In addition, the light projects an image the exact size and shape of the x-ray field. Thus, by positioning the x-ray device using the image of the cross hairs, the operator can insure that the proper portion of the patient is being x-rayed and that the size and shape of the x-ray field is correct prior to an x-ray being taken.

The x-ray monitoring camera of the instant invention replaces the lamp in the collimator. The camera may or may not use the same power source as the lamp. The wireless camera is capable of operating off the power source which was used by the lamp. The camera records the image reflected off of the mirror. The camera is capable of either taking still or video images. The operator can see the images sent by the camera on a video screen. Because the operator sees what the camera is “seeing,” the operator may use the camera images to aim the x-ray in the same manner as the lamp was previously used.

The cameral could be programmed to automatically take a picture or start video when the x-ray is triggered or the operator can use the camera to take a picture or start video. Because a permanent image may be preserved showing the exact area where an x-ray was taken, it may be used at a later date to insure that, if a second x-ray is needed, it can be taken from the exact same position as the first x-ray. This is a very valuable tool for comparing changes over time.

One of the major objects of the present invention is to provide a method by which an operator may aim an x-ray directly toward the area of interest on a patient.

Another objective of the present invention is to provide a record of the position at which an x-ray was taken.

Another objective of the present invention is to provide an x-ray monitoring camera which is simple, reliable, inexpensive, and easy to use and maintain.

These and other features of the invention will become apparent when taken in consideration with the following detailed description and the drawings.

### BRIEF DESCRIPTION OF THE DRAWINGS

FIG. 1 is a front view of a collimator implementing the instant invention;

FIG. 2 is a cross section view of the instant invention taken along line 2-2 of FIG. 1.

### DESCRIPTION OF A PREFERRED EMBODIMENT

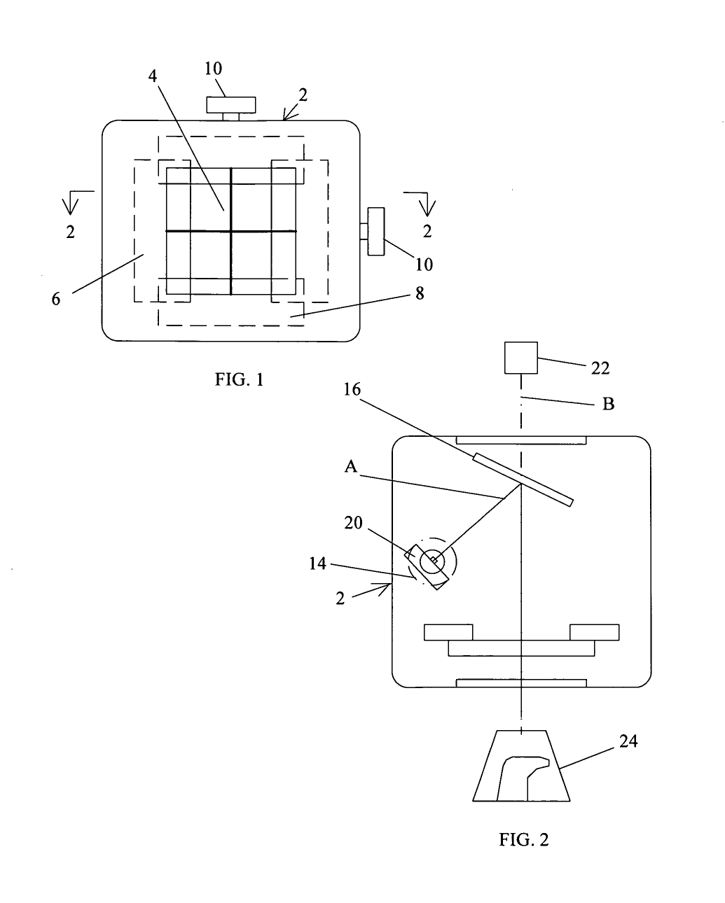

Referring to the drawings, FIGS. 1 and 2 there is shown a preferred embodiment of the instant invention. The x-ray monitoring camera of the instant invention is shown and described as being adapted to an existing collimator, but it could easily be incorporated into new collimators as well. An x-ray emitter emits x-rays through a collimator and a patient to an x-ray recording medium. The instant invention is a part of the collimator and none of the other features of an x-ray system will be depicted or described. They are all considered to be conventional. The part of a collimator closest to the x-ray emitter is considered the rear of the collimator.

Now referring to FIG. 1, a front view of a collimator implementing the instant invention is shown. A collimator 2 is generally a lead-lined, hollow box and x-rays pass through the collimator 2 from the rear to the front. Said collimator 2 includes a transparent plate 4 affixed to the front of said collimator 2. The transparent plate 4 includes cross hairs which cross in the center of said transparent plate 4. A vertical shutter 6 within said collimator 2 is interposed between the x-ray emitter and the patient. A horizontal shutter 8 is also interposed between the x-ray emitter and the patient. A vertical knob 10 controls the vertical shutter 6 and a horizontal knob 12 controls the horizontal shutter 8. Said vertical shutter 6 and said horizontal shutter 8 may be manipulated to control or frame the x-ray. Neither said vertical shutter 6 nor said horizontal shutter 8 are considered a part of the instant invention.

Referring now to FIG. 2, a cross section view of the instant invention taken along line 2-2 of FIG. 1 is shown. In conventional collimators, there is a lamp 14 placed inside said collimator 2 away from the centerline of said collimator 2. A mirror 16 is placed near the rear of said collimator 2 at the center of said collimator 2. The mirror is angled such that light from the lamp 14 is reflected of the mirror 16 and passes out of the collimator in the exact direction of the x-ray. X-rays pass through said mirror 16. Reflected light from said lamp 14 passes through said transparent plate 4 and causes an image of the cross hairs of said transparent plate 4 to be projected upon the patient. An operator may use the projected image of the cross hairs to aim the x-ray and insure that the correct portion of the patient is being x-rayed.

Still referring to FIG. 2, in this embodiment of the instant invention, said lamp 14 is replaced by a camera 20. The camera 20 may either be battery operated or operated from the power source for said lamp 14. Said camera 20 is pointed toward said mirror 16 such that the image of the area to be x-rayed is reflected off said mirror 16 and directly to said camera 20. This is illustrated by line A. Said camera 20 may be any of several conventional “mini” cameras which are wireless and have the capability of transmitting wireless images and video. Said camera 20 may be hard wired to the power source of said lamp 14 in any conventional manner. Said camera 20 transmits either still images or video to a screen which may be viewed by an operator and also stored if desired. The screen may be any of a number of conventional receivers, such as a computer, which is capable of receiving and storing images or video from said camera 20.

Still referring to FIG. 2, the passage of x-rays through said collimator 2 is illustrated. An x-ray emitter 22 sends the x-rays (line B) through said collimator 2. X-rays pass through said collimator 2 and an x-ray field 24 shows the area to be x-rayed.

In operation, an operator may view images from said camera 20 which show not only the area to be x-rayed, but also the cross hairs from transparent plate 4. The operator may use the camera images to aim the x-ray in the same manner as in the version of a collimator with a lamp. In addition, camera images may be stored for future reference. In the event that a second x-ray of the affected area is needed to determine changes over time, the stored image from the first x-ray may be used to insure that the second x-ray is taken of the same place and from the same position.

In the preferred embodiment all elements are conventional with structural element being made from steel although other materials having similar properties could be used. The camera used in the device is a Rohs Model 601 and described as a 2.4 gigahertz, mini pin hole camera with wireless. The camera is capable of wirelessly transferring images or video to a conventional receiver such as a computer. This camera is widely available through a number of sources. Any of a number of conventional cameras having similar property could be used.

I claim:

1. A x-ray monitoring camera for use with an x-ray system which includes a conventional collimator and x-rays enter through the rear of the collimator and, after having been adjusted by the collimator, pass through the front of the collimator, and the collimator having a light source and a power source for the light source and a mirror within the collimator and the mirror being incorporated near the rear of the collimator and being angled such that light from the light source is reflected by the mirror and projected in the same direction as the x-rays, comprising:
(1) a digital camera which replaces the light source and is capable of using the power source previously used by the light source and the lens of the digital camera is pointed toward the mirror and ambient light from the area to be x-rayed travels in the opposite direction as the x-rays, is reflected off of the mirror and directed toward the lens of said digital camera and said digital camera is capable of taking and transmitting images of the area to be x-rayed to an operator.

2. The x-ray monitoring camera of claim 1 in which said digital camera is powered by means other than using the power source for the light source.

3. A x-ray monitoring camera for use with an x-ray system which includes a conventional collimator and x-rays enter through the rear of the collimator and, after having been adjusted by the collimator, pass through the front of the collimator, comprising:
(1) a digital camera which is battery powered and which is placed within the collimator, the digital camera being placed within the collimator such that the camera is out of the path of x-rays which pass through the collimator, and the lens of said digital camera is pointed toward the center of the rear of the collimator;
(2) a mirror which is placed within the collimator near the rear of the collimator and the mirror is angled and positioned such that ambient light from the area to be x-rayed is reflected off said mirror and into the lens of said digital camera; and
(3) said digital camera is capable of taking reflected images of the area to be x-rayed and transmitting them to an operator.

4. The x-ray monitoring camera of claim 3 in which external power for said digital camera is provided within the collimator.
